(19) United States
(12) Patent Application Publication
(10) Pub. No.: US 2018/0328016 A1
(43) Pub. Date: Nov. 15, 2018

(54) WAY OUT VALVE FOR URINALS WITH A MORE EFFICIENT SEAL

(71) Applicant: Helvex, S.A. de C.V., Mexico City (MX)

(72) Inventor: Arturo Villalobos Lopez, Mexico City (MX)

(73) Assignee: Helvex, S.A. de C.V, Mexico City (MX)

(21) Appl. No.: 15/618,687

(22) Filed: Jun. 9, 2017

(30) Foreign Application Priority Data
May 11, 2017 (MX) MX/A/2017/006174

(51) Int. Cl. E03D 13/00; A47K 11/12; E03C 1/298; F16K 25/00

(52) U.S. Cl. CPC E03D 13/007; F16K 25/005; E03C 1/298; A47K 11/12

(57) ABSTRACT

The present invention is related with the accessory manufacturing industry for products such as faucets, showers, floaters, toilet seats, among others. It is more specifically related with the manufacturing of valves for dry urinals that allow the passing through of the urine and prevent the return of unpleasant odors. The invention consists in an assembled valve for the urinal's exit with a more efficient seal, characterized for including in a main body with bonding means, a superior one to fixate to a urinal and an inferior one to fixate to the plumbing that will hydraulically connect the main body of the valve to the drain exit. In the superior ending, this main body includes a pierced disc, where the urination will directly impinge, in the interior, slightly beneath half, the structure includes a disc with a centered orifice, this disc in its inferior face has a tubular projection that will be obstructed or liberated by the valve component of the valve's assemble; such inferior internal disc in its upper part has a very opened conic configuration.

### CROSS REFERENCE TO RELATED APPLICATIONS

This application claims the benefit of Mexican Patent Application No. MX/a/2017/006174 filed on May 11, 2017, which is incorporated by reference in its entirety in this disclosure.

### TECHNICAL FIELD

The present invention is related with the bathroom accessories manufacturing industry, with products such as faucets, showers, toilet seats among others. It is more specifically related with the manufacture of valves for dry urinals which allows the passing of urine avoiding unpleasant odors.

### BACKGROUND

There are different gadgets for the same application; however the difference between our device and others is that other units are based on a little ball that acts like a valve, allowing the passing through of fluids without coming back. This devices consists on a storage or chamber that contains the liquids and within this chamber there is a sphere that when the chamber is filled with fluid it floats above the surface of the fluid and allows it to pass through an orifice. As the level of urine decreases, the sphere descends until it sets in the base of the device and by its own weight seals the orifice, this is optimal and stable.

This is because there is no relation in this devises between the diameter and weight of the little ball with the conicity of the base and the diameter of the exit pierce. In the case of the ball if it is too light, it will allow an almost instant drainage with too little residual urine, but since It is so light the mere pressure of the drain gases that normally is of 0.1 bar, may provoke that the ball floats easily allowing the passing of bad odors; on the opposite case if the ball has a superior weight it will allow a good seal, but It will provoke a urine saturation that in some cases may even be visible in the urinal, besides it will generate a greater amount of residual urine, as for the base or ball base in this devices there still isn't a known relation between the conicity and the exit pierce, for that reason this units won't have an optimal functioning, either because there is no relation between the diameter and the weight with respect to the little ball or because there is no relation between the little ball with the conicity and the diameter of the liquid exit pierce.

As some example of the devices of the state of the art we can mention the disclosed units in the Mexican patents WO2012141565 and the WO2012039593, both property of Helvex S.A. de C.V.

The closest design to this patent application is disclosed in the patent WO2012064167 property of Helvex S.A. de C.V.

Structurally the sealing device for the dry urinal shown in this register is characterized to include a storage with a base in the bottom of the chamber with a decline conformation toward the center and a sphere that whenever the urinal is not being used seals with its weight the exit orifice of the base, and when the urinal its being used and the urine level reaches a certain level this sphere floats and stops sealing allowing the passing through of the urine from the chamber and into the drain, through the base orifice.

Nevertheless, even when the weight of the little ball is taken into consideration, there is no consideration regarding the relation of the diameter with the weight of the sphere neither is related the sphere with the diameter of the exit and the inclined plain of the base, for that reason since it is not taken into consideration such links, it makes that the device lacks of a stable sealing and with a greater amount of residual urine, that generates bad odors.

However, even though the design of this valves has improved in many ways, this improvement can't go further, because since the gas pressure is variable in the drainage, if the little ball was designed to be too heavy as to resist any pressure, it may put at risk the opening by floatation of the little ball. Namely, the urine passes through the exit because the little ball floats, and accordingly with Archimedes principle, it will float whilst the dislodged liquid (the urine that makes the little ball float) has the weight of the little ball.

Therefore, if the little ball is designed to be too heavy as to assure that the seal will prevent the passing of the drain gases, two thing occur, on one side that the residual urine in the chamber is too much and will any way provoke bad odors where the chamber is located in the urinal, or that in order for the ball to float and have the proper weight is designed to be too big, and it will be necessary to design a larger valve with a larger base, increasing the valve's selling price and calling for the urinal to be redesigned with all the implications in the design change.

Until now there have been 3 principles to achieve the seal that allows dry urinals to be accepted. The first was a hydraulic oil seal that allows the passage of urine to the drain and having a density greater than the oil and being Immiscible, then the urine passes and the oil serves as a barrier to drainage gases. This way of performing the seal has the inconvenient that the oil is dragged to the drain progressively and from time to time it must be changed.

The other is the seal provoked by the adhesive qualities of the internal walls of a very flexible hose, that from the effect of the liquid's weight that tries to circulate within it, expands its walls, allowing this way for the liquid to pass through, and once the weight stops acting the walls adheres among them sealing the passing through of the drain gases. In this case the same pressure of the gases tends to unite the walls provoking a better seal. This structure takes advantage of the pressure that is generated from the gases that are meant to be stopped, in order to prevent its exit. The problem with this seal is that the salts contained in urine will progressively be embedded in the walls and the seal will be increasingly inefficient requiring a frequent maintenance.

Finally we have the little ball seal that has already been analyzed and has a very good performance but has the inconvenience of not responding to normal changes of the pressure of the drain gases.

### SUMMARY

One of the objectives of this invention is to achieve a valve mechanism to dry urinal that the some way responds to the pressure change of the gases in the drain.

Another objective is that said valve be helped in his seal by the own drain gases pressure.

Still another objective is to not have to modify the dimensions of the valve for situations where the drainage gas pressure is relatively high.

Another objective is to make possible a valve that regardless of the normal pressure in some geographical area, the size of the urinal will not change.

And all those objectives and advantages which will be a patent from the reading of the present description and the drawings which, for illustrative purposes, but which are not limitative, are appended hereto and form an integral part thereof.

### BRIEF DESCRIPTION OF THE INVENTION

One aspect that has been overlooked in the design of valves for dry urinals is that the seal on a valve is more efficient when the flow to be interrupted contributes to the closure of the valve. Of course the hose valve is thin and flexible if it takes this advantage.

For example, in the discharge valve of the tanks in the toilets of the state of the art, it is the own weight of the water column that drives the cone against the base to interrupt the passage of the water.

In the case of the urinal valve consisting of a flexible hose, in this case also the pressure of the gases helps in the sealing of thereof.

The present invention also respect this principle of a seal on a valve aided by the flow itself pretend to be stopped. That is, in our case, the flow of gases that is interrupted by their own pressure on the valve.

For this, two modalities were designed, one consisting of a rocker that in its equilibrium position touches the base in which the sealant element of the valve will be placed to interrupt the flow of the drainage gases. This rocker valve has at one end of the component that pivots the sealing elements and at the opposite end has a weight of such a magnitude only allows the sealing element to be slightly seated on the base, so that the arrival of an amount even Small of liquid, automatically opens the valve by breaking the seal. When there is no liquid above the valve, the rocker is put back with the component with the sealing element on the base. When the gas pressure hits the sealant member of the rocker this presses the seal onto the base and the gases cannot flow.

In addition to the dimension of the counterweight placed on the opposite element the sealant member of the rocker, there is also important length and ratio of lengths of the lever arms present on the rocker arm and the point where the fulcrum is located.

The other modality will be a valve in which the sealant member is held in its base by means of a pair of deformable elements characterized in that the force to achieve its deformation is slightly higher than the weight of the component with the sealing element. In this way, when an amount of liquid, even very small, is impinged on the sealing element, this it moves downwards, by deforming the deformable elements. When there is no urine in the valve, the deformable elements return to their original length and drag the component with the sealant element until it base in the valve base with a very light force. As the drainage gases tend to come out, their own pressure pushes the sealing element against the base, sealing more strongly and avoiding the passage of these.

It is clear that the material of the deformable elements is important, by constant contact with the urine. It requires a material that in addition to its mechanical properties of deformation capacity (Young's module) also requires a chemical anti-incrustation capacity.

In a preferred modality the deformable elements are in the form of a spring and in another also preferred mode, the deformable elements may consist of elastic bands.

In relation to the deformable elements, they also have to do with the sealant element. If this sealing element, in the modality of the rocker as in the one of traction by deformable elements, allows that they incrust to him salts like the oxalatos of calcium, its sealant efficiency begin to be demerited.

A combination of these valves at the bottom of the body with a ball seal at the top reinforces the possibility of avoiding leaks of drainage gases into the spaces in which the urinals are located with these valves.

It is clear that the base of the ball in the upper body of the valve must comply with two characteristics, on the one hand, that is able to seal by the own weight of the ball on it and on the other, that has resistance to incrustations . For this, it is possible to place an inlay, not of salts but of an anti-incrustation material, in the body of the base, or the whole body of the base may be of this anti-incrustation material.

### BRIEF DESCRIPTION OF THE DRAWINGS

FIG. 1 illustrates the modality in which the valve of the urinal consists of a rocker valve in the closed position, showing the lines representing the flow of the gases.

FIG. 2 illustrates details of the rocker with the component in which the counterweight is located and the component where the sealant element.

FIG. 3 illustrates the embodiment in which the urinal valve consists of a valve of deformable elements constituted by springs, in a closed position showing the lines representing the flow of the gases.

FIG. 4 illustrates the modality in which the valve of the urinal consists of a valve of deformable elements consisting of elastic bands, in closed position, showing the lines representing the flow of the gases.

FIG. 5 illustrates the association of the rocker valve with the ball valve, in closed position, showing the lines representing the flow of the gases.

FIG. 6 illustrates the association of the deformable element actuating valve with the ball valve in closed position showing the lines who represent the flow of the gases.

FIG. 7 illustrates the modality of ball valve with rocker, and sphere with deformable element with ball, both in the open position.

### DETAILED DESCRIPTION OF THE INVENTION

The present invention has several aspects, tending to improve the seal of the outlet valve of the urinals without water use. Said valve consists of a main body which in its upper part comprises a means of attachment to be fixed to the urinal. On the other hand, in its lower part also has a means of attachment to be fixed to the pipe that will hydraulically connect the main body of the valve, to the exit to the drainage. At the upper end, this main body comprises a disk with perforations, where the urination is to be directly impinged, when the user is urinating.

In one of their preferred modality, these fastening means consist of external threads for fixing to the urinal and the tube toward the outlet to the drain, by means of nuts.

In the interior, slightly below the middle, the structure comprises a disc with a central orifice to direct the urine towards the tube that connects to the drainage. This disk by its lower face has a tubular projection that is going to be obstructed or released by the component that would come to be the valve itself, although by extrapolation we call valve to the valve itself together with the main body with their respective threads, lower disk with its tubular projection and the upper disk with holes.

Said lower inner disk, at the top, has a very open conical configuration to facilitate the concentration of the urine in the center, and the subsequent evacuation towards the tube that will lead to the drainage.

In this aspect there are several modalities that will depend on the ease of manufacture and other factors. One modality of this valve is that the main body with its ropes or threads, as well as its upper disk with holes and the lower one with its central orifice and its central tubular projection are in one piece or, in other words, it is a monolithic piece.

However, in another preferred modality, for ease of manufacture and ease of maintenance, the main body is comprised of three parts, two telescopic cylinders, one shorter internal and the other external more longer. The third piece is the lower inner disc.

The longer outer cylinder is the one that comprises the upper outer threads for attachment to the urinal by means of a nut and the lower one for attachment of the main body of the valve to the tube which will lead the urine to the drainage pipe.

The shorter telescopic tube is the one that comprises the upper disk with holes, fixed or forming a single monolithic body and it is in this shorter telescopic inner cylinder where the inner lower disc is embedded with the upper face in open cone configuration and with the underside with tubular projection.

The lower tubular projection of the lower inner disc in turn has transverse cylindrical projections where will be install, depending the modality, the fulcrum of the rocker or one of the ends of the elastic bodies which maintained in closed position the valve itself, when this corresponding to a piston valve.

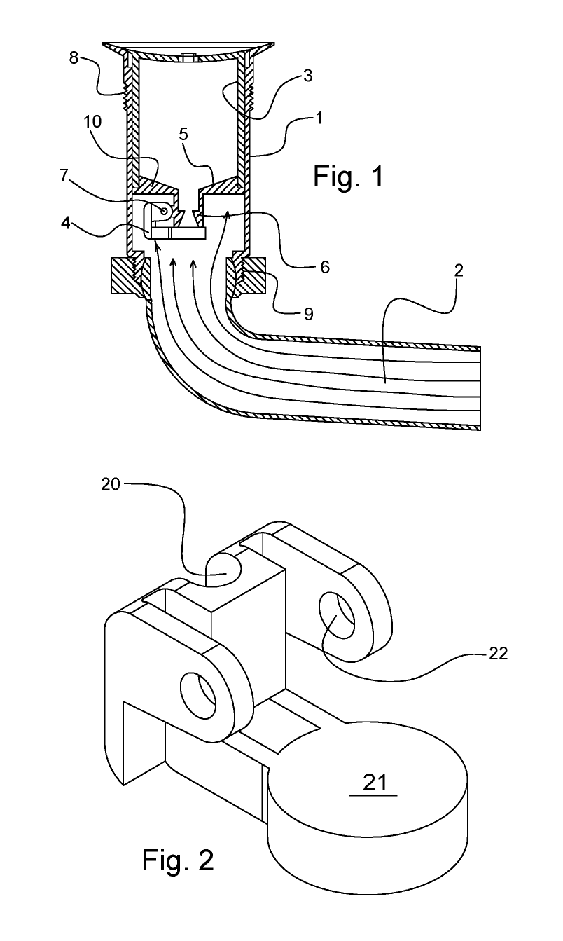

FIG. 1 illustrates the modality in which the urinal valve consists of a rocker valve 4 in the closed position, showing the lines representing the flow of gases 2.

In this figure the external telescopic tube 1 can be visualized with the thread Top 8 and the lower thread 9. The inner telescopic tube 3 has the lower disc 10 with the top face 5 in very open conical configuration and the tubular projection 6 on the underside of said disc.

The rocker valve 4, itself has the fulcrum 7 in the lateral projections of the tubular projection of the lower disk 10.

FIG. 2 illustrates the details of the rocker with the component in which the counterweight 20 is located and the component where the sealing element 21 is located, with the fulcrum 22 where the rocker is pendulously attached to the lateral projections of the lower tubular projection of the lower inner disc. In counterweight in the element 20 has a magnitude such that it maintains the rocker with the component with the sealing element slightly in contact with the seat comprised in the lower tubular projection of the lower inner disc. While this light contact would not seal completely to prevent passage through the rocker valve, but as the pressure of the drainage gases coalesce into the sealing member and increase said sealing.

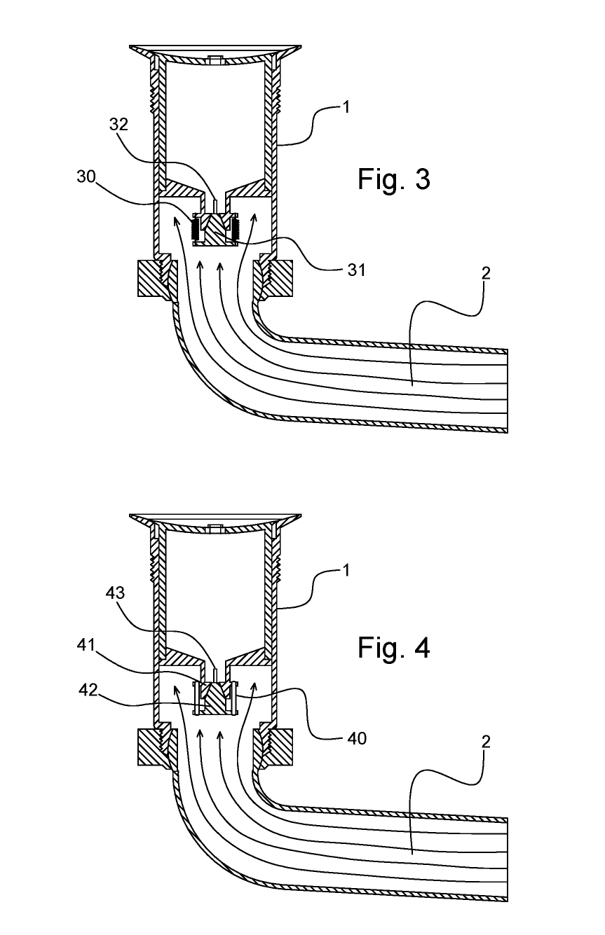

FIG. 3 illustrates the modality in which the valve of the urinal consists of a valve of deformable elements consisting of springs 30, in a closed position showing the lines representing the flow of the gases 2. In this modality, to increase the seal surface between the tubular projection and the piston 31, so called by the movement within the tubular projection in the manner of a piston in a cylinder. In order to facilitate return to the closed position and to prevent the plunger from completely falling out, the plunger has a tapered configuration and a section which could be cylindrical where the lateral projections would be located to fix the ends of the springs, the opposing ends Are attached to the lateral projections of the lower tubular projection of the lower inner disc.

Somewhat further to guide the sealing plunger 31 towards the corresponding part of the tubular projection of the inner lower disk in its closed position the plunger carries at its distal end a rod 32. Again, the deformable elements do not require much pressure So that the plunger seals very strongly against the corresponding face of the tubular projection, it is sufficient that the deformable elements place the outer surface of the plunger in light contact with the corresponding surface of the tubular projection and the own pressure of the drainage gases will increase the contact force of the plunger and will result in a seal sufficient to prevent the exit of the drainage gases.

FIG. 4 illustrates the modality in which the urinal valve consists of a valve of deformable elements consisting of elastic bands 40, in a closed position, showing the lines representing the flow of the gases 2.

The elastic bands to be fixed on one side to the lateral projections of the tubular projection of the inner lower disk and on the other side to the lateral projections of the sealed piston, in one of its modality will consist of a hole with the edge reinforced in some way. This reinforcement could be an eye or a treatment of the edge of the hole.

To reduce the risk of these deformable elements separating from one of the two projections, there are various solutions such as deformation of the projections, such as a hook or even a flattening of the end in the manner of a rivet.

The conformation of the strips can be very diverse, having a conformation of round, triangular, rectangular, cross-sectional configuration, among others. The most efficient would be the round or square cross-section, with a bushing to attach a hook at its ends. A rectangular band would only employ a small longitudinal surface of the entire available area, so the thickness would have to be higher to reach the targets and much material would be wasted.

For issues regarding the sealing surface increase, it was chosen a 42 plunger with a tapered ending; with a zone of the tubular projection's internal walls below the disc. In its inferior endpoint 41 thickened in a tapered shape in a configuration that allows to accommodate the 42 plunger. As an additional detail, in order to guide the plunger to its closed position and avoid that it will completely get out, a 43 rod was added.

All of the other elements that integrate the valve's assembling they have already been mentioned in the description of the previous figures and we will only point the 40 lengthwise deformable band.

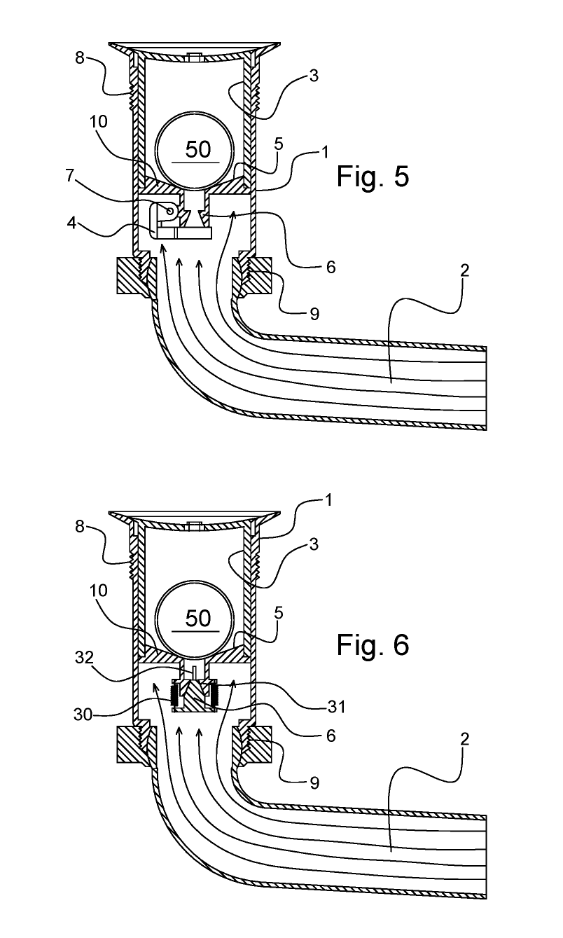

The FIG. 5 illustrated the association of the rocker's valve, with the sphere or little ball's valve in closed position, showing the lines that represents the gas flow.

As it may be appreciated, the difference between this figure and FIG. 1 only consists in the presence of the 50 little ball. This way it might be changed in the production process, the options of the valve with a little ball and the rocker or only the assemble of the rocker's valve, only by adding the little ball or sphere or not doing it.

Even though, as we previously stated the main body may be a single piece, for manufacturing and maintenance effects, within the figures of this description we are taking into consideration that the main body is formed by two telescopic cylinders, having the external cylinder, the bonds to the urinal and the hydraulic connection tube with the exit to the drain and the internal cylinder being shorter and including the superior adhered disc or constituting a part of the same thing and inlay the internal inferior disc with the superior shape in a very opened conic shape, and in the inferior shape the tubular projection for the rocker's valve setting.

FIG. 6 illustrate the association of the activation valve of deformable elements with the sphere or little ball valve in a closed position, showing the lines that represent the flow of gases.

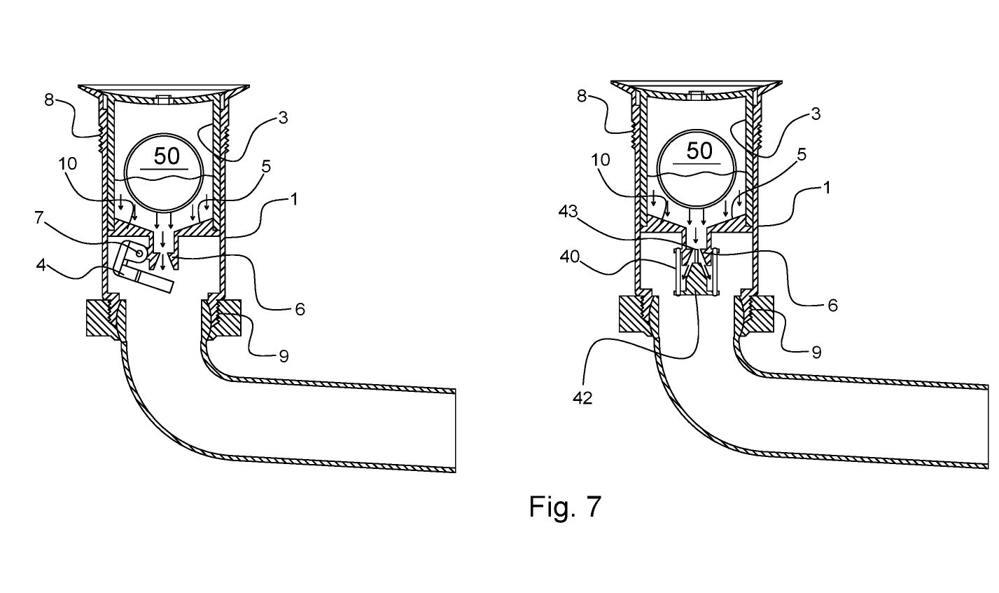

FIG. 7 illustrates the modality of the sphere valve with rocker, and the sphere with deformable element and sphere, both in closed position.

The invention has been sufficiently described so that a person of ordinary skill in the art can to reproduce and obtain the results mentioned herein. However, any skillful person that in the field of art to which the present invention may be able to make modifications not described in this application, however, if required for the implementation of these changes in a process of free-lactose milk, it is required the matter claimed in the following claims, such systems must be within the scope of the invention.

1. Assembling of the urinal exit valve with a more efficient seal, characterized for including a main body with bonds, a superior bond to fixate in a urinal and an inferior bond to fixate in the plumbing that will connect hydraulically the main body of the valve to the drain exit, in the upper end, this main body includes a pierced disc that will directly impinge with the urination. When the user is urinating in the interior slightly below half, the structure includes a disc with a centered orifice to direct the urine towards the tube connected to the drain. This disc has a tubular projection in its inferior face that will be obstructed or liberated by the component of the valve, from the valve assembly; such internal inferior disc in its upper part has a very opened conic configuration to facilitate the urine concentration in the center, and the ulterior dislodge into the tube that will conduct it to the drainage.

2. Assembling of the valve to exit in the urinal with a more efficient seal, as claimed in the previous claim, furthermore, characterized because the main body is formed by 3 pieces, two telescopic cylinders, a shorter internal cylinder, the external cylinder longer, and a disc with an orifice; the external cylinder longer, is the one that includes the external screws, the upper one for the fixation to the urinal through a nut and an inferior one for the fixation of the main body of the valve to the tube that will conduct the urine to the drainage plumbing; the shorter telescopic tube is the one that includes the superior pierced disc, fixated and forming a single monolithic body, and it's in this shorter internal telescopic cylinder where its crammed the inferior internal disc with the superior face with the open conic configuration and the inferior face With tubular projection.

3. Valve's assembling for the urinal exit with a more efficient seal, as claimed in claim 1, furthermore characterized because the tubular projection includes 2 side projections where the orifices are hooked in the location of the 22 fulcrum of a piece with a component where the counterweight 20 is located and another component where the sealing element 21 is placed, with this component forming a 90° angle and being hooked in the side projections of the tubular projection of the internal inferior disc, It is fixated in a swinging way to the side projections of the inferior tubular projection of the inferior internal disc being the sealing element in its position, it touches the base of the tubular projection.

4. Valve's assembling for the urinal exit with a more efficient seal, as claimed in claim 3, furthermore characterized because the counterweight in the element 20 has such a magnitude that maintains the rocker with the component having the sealing element slightly in contact with the included base in the tubular projection of the inferior internal disc.

5. Valve's assembling for the urinal exit with a more efficient seal, as claimed in claim 1, furthermore characterized because the tubular projection includes two side projections where the orifices of the edges in the elastic bodies are hooked, which counter edges will hook to the corresponding projections of a tapered piece, such tapered piece has a vertex to the superior part and matches in the inferior ending of the tubular projection, concurring the external surface of the tapered piece, so-called piston or plunger, with a thickening of the interior wall in the inferior ending of the tubular projection, having such thickening a conic configuration with the vertex upward.

6. Valve's assembling for the urinal exit with a more efficient seal, as claimed in claim 5, furthermore characterized because the elastic bodies are selected among a sprint or an elastic band of different configurations such as a round, square or rectangular cross section.

7. Valve's assembling for the urinal exit with a more efficient seal, as claimed in claim 6, furthermore characterized because in the superior face of the inferior internal disc is where the little ball or sphere is located and that it may also block the urine flow downward.
